(19) United States
(12) Patent Application Publication
(10) Pub. No.: US 2003/0072910 A1
(43) Pub. Date: Apr. 17, 2003

(54) Light-shielding cloth and light-shielding container for photosensitive material using same

(75) Inventors: Satoru Tsurumaki, Kanagawa (JP); Masazumi Tomoda, Fukui (JP); Toshihiro Kondou, Fukui (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD

(21) Appl. No.: 10/279,824

(22) Filed: Oct. 25, 2002

Related U.S. Application Data
(63) Continuation-in-part of application No. 09/898,078, filed on Jul. 5, 2001.

(30) Foreign Application Priority Data
Jul. 5, 2000 (JP) 2000-203813

(51) Int. Cl. B32B 3/02; D04H 11/00

(52) U.S. Cl. 428/92; 428/85; 428/96

(57) ABSTRACT

A light-shielding cloth that is to be bonded to a slit-form opening of a container for a photosensitive material is formed from a base fabric and a crimped pile thread incorporated into the base fabric so that the pile density is in the range from 45,000 filaments/cm² to 85,000 filaments/cm², a hot-melt adhesive region being provided on the reverse side of the base fabric without a filling agent being applied thereto for the purpose of preventing the hot-melt adhesive from penetrating the base fabric. A container for a photosensitive material is formed by bonding the light-shielding cloth to a slit-form opening using a 100% solids adhesive, preferably an ethylene-vinyl acetate copolymer resin based adhesive, without a treatment with a filling agent. A narrow-width light-shielding ribbon is formed by slitting the light-shielding cloth by means of an ultrasonic slitter.

### BACKGROUND OF THE INVENTION

1. Field of the Invention

The present invention relates to a light-shielding container that stores a photosensitive material such as printing paper, photosensitive material for printing or color negative film for photography. The present invention also relates to a light-shielding cloth provided on a slit-form opening through which the photosensitive material is inserted into and taken out of such a container, that is to say, plush.

2. Description of the Related Art

Photographic 35 mm roll film, etc. is used in a state in which it is stored in a light-shielding container called a cartridge. As is well known, this cartridge is basically formed from a tubular iron shell, a spool as a wind core for winding a film stored in the shell in a roll form, and caps for closing the two ends of the shell. Moreover, light-shielding cloth, generally called plush (also called teremp), is bonded to the inner surfaces of a film passage opening of the above-mentioned shell.

Since the light-shielding cloth is required to prevent unused film from being exposed to light and should also not interfere with the smooth drawing out and rewinding of the film, a light-shielding cloth structure made of a flexible material having a pile on the surface of a base fabric is used as the light-shielding cloth.

Conventionally, light-shielding cloth structures of this kind are produced by weaving or knitting superimposed woven cloths or knitted cloths with a pile thread so as to combine the cloths thus giving double woven or knitted cloths, and then cutting the pile thread on a plane that is almost central between the two woven or knitted cloths (Japanese Patent Application Laid-open No. 62-98347). The plush is in contact with the photographic film so preventing the film from being exposed to light, and its flexibility and resistance to drawing out of the photographic film are sufficient for ordinary use.

Conventionally, these light-shielding cloth structures are coated with a filling agent and an adhesive. The filling agent is used in order to prevent the pile threads from dropping out of the base fabric and prevent the adhesive from penetrating into the pile section. With regard to examples of the filling agent, as disclosed in Japanese Patent Application Laid-open Nos. 62-55649, 62-71949, 62-27733 and 2-72348, there are synthetic emulsions of polyvinyl, polyolefin, polyurethane, polyamide, polyester, synthetic rubber, epoxy, phenol and other acrylic systems, blended emulsions of more than one type chosen from the above-mentioned synthetic emulsions, and copolymer emulsions obtained by combining the above-mentioned components.

The adhesive is used in order to bond the light-shielding cloth structure to the main body of the photographic material storage container. With regard to examples of the adhesive, there are commercial double-sided adhesive tapes, adhesives based on, for example, polyolefin systems such as polyethylene, vinyl acetate copolymer systems such as ethylene-vinyl acetate copolymer, acrylic acid copolymer systems such as ethylene-ethyl acrylate and ethylene-isobutyl acrylate, polyamide systems such as nylon-6, nylon-6,6, nylon-10, nylon-12, N-methoxymethylated nylon, polyester systems such as terephthalic acid systems, polyvinyl butyral systems, poly(vinyl acetate) systems, cellulose derivative systems such as cellulose acetate, methylcellulose and cellulose acetate butyrate, polymethacrylate ester systems such as poly(methyl methacrylate), poly(vinyl ether) systems such as poly(vinyl methyl ether), polyurethane systems, polycarbonate systems, styrene system block copolymer systems such as styrene-ethylene-butylene-styrene, synthetic rubber systems such as styrene butadiene, isoprene and butyl rubber, other special rubber systems and other acrylic copolymers, and mixtures of more than one type of adhesive chosen from the above-mentioned adhesives.

The filling agent is used particularly in order to prevent an adhesive having a low viscosity from penetrating the reverse side (coated surface) of the base fabric and passing through to the front surface. In the case where the adhesive can be adjusted so as not to penetrate the light-shielding cloth, it is unnecessary to apply a filling agent, which is preferable in terms of cost, simplicity of equipment, etc. Although Japanese Patent Publication No. 5-88455 discloses an invention in which an adhesive alone is coated without the use of a filling agent, the pile threads cannot adequately be prevented from dropping out of the base fabric and the light-shielding properties cannot be ensured since the pile threads are crushed during coating. Moreover, conventional 100% solids hot-melt adhesives cannot guarantee adequate adhesive strength between the plush and the cartridge shell, there is a possibility that the plush might be peeled off when inserting the two ends of the tube-forming section into the caps and light might leak through a gap formed by the cloth peeling, thus causing the problem of exposure to the light so admitted. Furthermore, there are the problems that, depending on the environment in which the photographic film is used, the plush might become peeled off from the cartridge shell and, in particular, if a camera loaded with a photographic film is left in a vehicle in summer, the camera and the section of the plush that has been coated with the adhesive might become bonded together, thus not only contaminating the camera, but also preventing the photographic film from being removed.

In the case where a 100% solids hot melt adhesive is coated on the above-mentioned light-shielding cloth structure without using a filling agent, a conventional adhesive cannot give an adequate filling effect and the pile threads drop out of the base fabric. When the pile threads drop out of the base fabric, not only is the production line contaminated, but also when pile threads that have dropped out become attached to the film, the threads appear in pictures taken by a user so giving rise to a user complaint about, for example, an image fault.

Furthermore, since a 100% solids hot-melt adhesive generally has a high viscosity and poor fluidity, when coating the adhesive on a base fabric it is necessary to press a coating head against the base fabric. In conventional light-shielding cloth structures, the pile threads are crushed by coating and it is therefore difficult to ensure adequate light-shielding properties. In order to prevent crushing during coating, if the pile density is increased the resistance to drawing out the photographic film increases so causing damage to the film surface, or it becomes impossible to wind out and rewind the film in the camera. If the fluidity of the adhesive is enhanced by increasing the temperature at which the adhesive is melted in order to prevent crushing during coating, the pile threads are crushed due to heat and it becomes impossible to ensure adequate light-shielding properties.

Furthermore, with regard to a method of preventing the crushing of pile threads during the coating of an adhesive, there is a method in which a base fabric is impregnated with a lubricant such as one disclosed in Japanese Patent Publication No. 6-10748 in order to reduce the resistance to drawing out of a photographic film while increasing the pile density so preventing crushing. However, this method has the problem that peeling easily occurs at the interface between the base fabric and the adhesive and an adequate adhesive strength cannot be obtained.

Furthermore, in a step in which the base fabric is slit into narrow strips after coating the adhesive, resin residue becomes attached to the slitting blade so making the fabric less suitable for slitting, and as a result the product yield of plush manufacture decreases. Moreover, if the resin residue remains attached to the base fabric, the resistance to drawing out the film increases and the film might be damaged while rewinding so causing an image fault and resulting in a user complaint.

### BRIEF SUMMARY OF THE INVENTION

The present invention has been carried out in view of the above-mentioned circumstances, and it is a first object of the present invention to provide an inexpensive plush having satisfactory adhesive strength which is also suitable for ultrasonic slitting. It is a second object of the present invention to provide an inexpensive light-shielding cloth structure that ensures an adequate light-shielding properties and has a low compression resilience, and a light-shielding container for a photosensitive material such as a photographic film using same. It is a third object of the present invention to provide a plush that requires neither treatment with a filling agent nor the use of an adhesive containing an organic solvent, etc.

In accordance with a first aspect of the present invention in order to achieve the above-mentioned objects, there is provided a light-shielding cloth comprising a base fabric having first and second opposing surfaces, crimped pile threads incorporated into the base fabric and protruding from said first surface of the base fabric, said threads having a pile density in the range of 45,000 filaments/cm² to 85,000 filaments/cm², and a hot-melt adhesive provided on said second surface of the base fabric, without a filling agent between the base fabric and the adhesive.

The base fabric preferably has a woven or knitted structure, and more preferably a knitted structure comprising a chain thread and an inlay thread.

The hot-melt adhesive is preferably a 100% solids type.

The ‘incorporated into the base fabric’ referred to here means woven into a woven cloth or knitted into a knitted cloth.

In accordance with a second aspect of the present invention in order to achieve the above-mentioned objects, there is provided a light-shielding container for a photosensitive material formed by providing a light-shielding member on a slit-form opening through which the photosensitive material passes, the two sides of the slit-form opening comprising in cross section a light-shielding container main body, a hot-melt adhesive region and a light-shielding cloth comprising a base fabric having first and second opposing surfaces, crimped pile threads incorporated into the base fabric and protruding from said first surface of the base fabric, said threads having a pile density in the range of 45,000 filaments/cm² to 85,000 filaments/cm², without a filling agent being applied to the second surface of the base fabric.

The light-shielding container for a photosensitive material of the present invention is particularly preferably a cartridge for 135 format film.

In accordance with a third aspect of the present invention in order to achieve the above-mentioned objects, there is provided a narrow-width light-shielding cloth obtained by cutting the wide-width light-shielding cloth according to the first aspect by means of an ultrasonic slitter.

The ‘narrow-width’ referred to here is preferably 2 to 30 mm.

In accordance with a fourth aspect of the present invention in order to achieve the above-mentioned objects, there is provided a light-shielding cloth according to either one of the above-mentioned first aspect or third aspect wherein the composition of the hot-melt adhesive is 40 to 50 parts by weight of an ethylene-vinyl acetate copolymer resin, 25 to 35 parts by weight of a tackifier, 5 to 15 parts by weight of inorganic fine particles and 10 to 20 parts by weight of a wax.

In accordance with the above-mentioned arrangements, a plush that has adequate adhesive strength and is suitable for ultrasonic slitting without causing pile threads to drop can be obtained with low cost. Furthermore, a 100% solids adhesive can be applied as a layer to the plush without crushing the pile threads, degrading the light-shielding properties or increasing the resistance of a photographic film to being drawn out.

### BRIEF DESCRIPTION OF THE SEVERAL VIEWS OF THE DRAWINGS

FIG. 1 is a front view of one example of a shell-forming metal sheet in which two pieces of light-shielding plush are bonded to the right and left edges thereof using light-shielding plush ribbons of the present invention.

FIG. 2 is a cross section of one example of a photographic film cartridge using the shell-forming metal sheet with the light-shielding plush shown in FIG. 1.

FIG. 3 is a magnified top view of a light-shielding cloth formed from a double Raschel knitted fabric as one embodiment of the present invention.

### DETAILED DESCRIPTION OF THE INVENTION

The light-shielding cloth of the present invention (also called ‘light-shielding cloth structure’ or ‘plush’) comprises a base fabric section and a pile section formed from a pile incorporated into the base fabric section so that the pile section is formed from a compact erect pile having a uniform length. The pile here is a multi-filament type, and as described below a crimped bulky pile thread is used in the present invention. With regard to representative examples of the plush base fabric used in the present invention, there are those having a woven structure comprising a warp and a weft, those having a knitted structure comprising a chain thread and an inlay thread and those knitted and teaseled. In the present invention the base fabric preferably has a woven structure or a knitted structure, and most preferably a knitted structure.

The base fabric side of the plush of the present invention, that is to say, the reverse side of the base fabric is provided with a hot-melt adhesive region, without subjecting it to a treatment with a filling agent, and is bonded to two inner surfaces of a slit-form opening of a light-shielding container main body through which a photosensitive material passes. The plush pile sections bonded to the two inner surfaces of the slit-form opening face each other so forming a light-tight state and are in direct contact with the photosensitive material that passes through the opening while preventing light from leaking into the light-shielding container as well as decreasing the resistance to drawing out so as not to damage the photosensitive material.

As a result of an intensive investigation by the present inventors, it has been found that in order to directly form a hot-melt adhesive region on a base fabric by a hot-melt die coater, etc. without subjecting the plush to a treatment with a filling agent, it is important to chose a combination of pile density and pile type, and the present invention thus has been accomplished. That is to say, the plush of the present invention is a fabric in which crimped pile threads are applied to a base fabric at a pile density of at least 45,000 filaments/cm² and at most 85,000 filaments/cm² (also termed ‘45,000 to 85,000’, this applies to other expressions in the present invention). The pile threads used in the present invention are of a filament type rather than a spun type. Bulky threads obtained by crimping filament threads are used. These bulky filament threads are formed by changing the shape of the threads so as to increase their bulk. The pile density referred to above denotes the number of filaments per square centimeter.

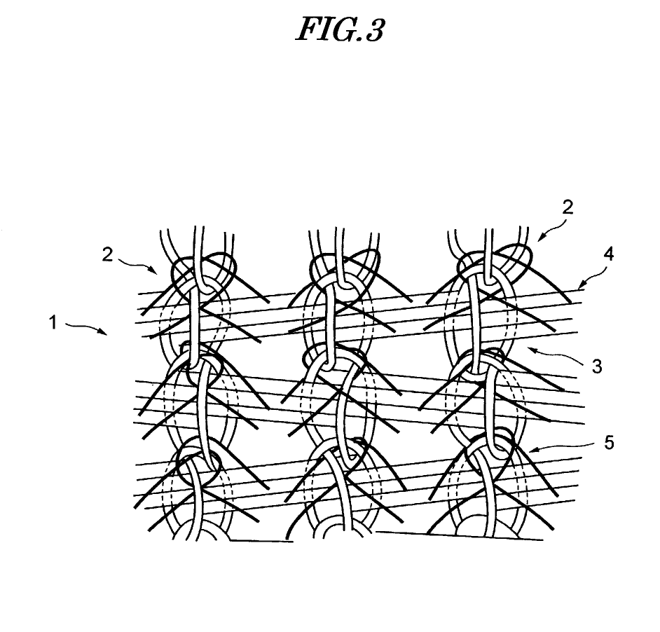

FIG. 3 is a magnified top view of a light-shielding cloth formed from a double Raschel knitted fabric as one embodiment of the present invention. As hereinbefore described, the light-shielding cloth comprises a base fabric section 1 and a pile section 2 that is incorporated therein. In the figure, 3 denotes a chain thread forming the base fabric and 4 denotes an inlay thread. The light-shielding cloth shown in FIG. 3 is produced by firstly linking two sheets of double Raschel knitted base fabric front to back with a pile thread and then center-cutting the base fabrics, that is, cutting the pile thread linking the two sheets of base fabric front to back. In the double Raschel knitted fabric so linked, there are two pile threads (multi threads) per knot, and by center-cutting it the pile section 2 is formed from four pile threads (multi threads) per knot as shown in FIG. 3. Multi filaments, which will be described later, are used for the pile thread, and the pile density can therefore be calculated from the following equation.

Pile density=(course density per inch)×(wale density per inch)×(number of filaments per pile thread)×(number of pile threads per knot of base fabric)÷2.54+2.54

With regard to a representative method of producing bulky filament threads used for the plush of the present invention, there is a method in which filaments are subjected to crimping. With regard to detailed methods of crimping there can be cited, for example, a method (1) in which a filament thread is fed between heated small gears so as to impart the shape of the teeth, a method (2) in which a filament thread is fed between rollers so as to impart a false twist, to make the thread heat-fixing and finally to untwist in a continuous fashion, a method (3) in which a filament thread is fed in a heated box by a feeding roller rotating in a high speed followed by heat-fixing the filament in a crooked state and a method (4) in which macromolecules having a different rate of thermal shrinkage from each other are spun in, for example, a side by side form and heated in a thread or fabric state so as to exhibit crimping.

With regard to the crimp characteristics of the bulky thread used as a pile thread, the stretch recovery according to JIS L-1090 is preferably 10% to 60%, and more preferably 20% to 40%. When the stretch recovery is less than 10%, an adequate bulkiness cannot be achieved and there is a possibility that the light shielding properties might be degraded to a great extent. When it exceeds 60%, since the bulkiness increases a required pile compression characteristic cannot be obtained and there is a possibility that the drawing resistance might undesirably increase.

In the plush of the present invention, a bulky thread from which the pile is formed preferably has a thickness of 56 to 167 decitex and comprises 24 to 100 filaments. More preferably, a multi-filament thread having a thickness of 56 to 89 decitex and comprising 30 to 80 filaments is used. With regard to the multi-filament thread used in the present invention, a synthetic fiber that is formed from a polyester such as PET or a polyamide such as nylon-66 is preferred.

The plush of the present invention has a pile density of 45,000 to 85,000 filaments/cm², and preferably 50,000 to 75,000 filaments/cm².

The height of the pile, that is the pile thickness, in the plush of the present invention is preferably 1 to 2 mm including the base fabric.

The adhesive region of the base fabric via which the plush is glued to the container (cartridge) main body is formed from at least one layer of hot melt adhesive. The adhesive region can be made in the form of strips or islands, but it is preferable for the adhesive to form a thin continuous area, and it is particularly preferable to form a continuous adhesive layer.

The form of hot-melt adhesive used in the present invention is preferably a 100% solids type that is solid at room temperature and exhibits fluidity when heated. The solid hot-melt adhesive preferably has a fluidity of 200,000 to 300,000 mPa·s when heated at 200° C. and 400,000 to 500,000 mPa·s when heated at 180° C. The fluidity is a value measured using a Brookfield type viscometer with a thermocell.

With regard to a hot-melt adhesive having a fluidity in the ranges above, an ethylene-vinyl acetate copolymer resin having a vinyl acetate content of 20 to 30%, a melt index of 2 to 5 g/10 minutes and a softening point of 150 to 190° C. can be used and, for example, an ethylene-vinyl acetate type copolymer adhesive having as a base Evaflex 360 (made by Du Pont-Mitsui Polychemicals Company, Ltd.) can be cited. The hot-melt adhesive used in the present invention preferably contains, in addition to the copolymer above, an aromatic petroleum resin tackifier having a melting point of 130 to 150° C. such as, for example, Nisseki Neopolymer 140 (made by NIPPON PETROCHEMICALS CO., LTD), inorganic fine particles such as talc and a wax such as a polyethylene wax having a melting point of 90 to 110° C. and a narrow molecular weight distribution. The composition of the hot-melt adhesive used in the present invention is preferably 40 to 50 wt % of an ethylene-vinyl acetate copolymer resin, 25 to 35 wt % of a tackifier, 5 to 15 wt % of inorganic fine particles and 10 to 20 wt % of a wax. Furthermore, in order to eliminate transparency of the base fabric and introduce light-shielding properties, it is preferable to add carbon black such as, for example, 2 to 5 wt % of Mitsubishi carbon black #44 (made by Mitsubishi Chemical Corporation) to the hot-melt adhesive and knead the mixture well so as to disperse the carbon black. When the amount of carbon black added is less than 2 wt %, the plush thereby obtained cannot show adequate light-shielding properties, and the final film cartridge product tends to have defects such as exposure of the film to light. When the amount added exceeds 5 wt %, there is a possibility that the adhesive power might be degraded and the viscosity might increase so resulting in a deterioration in coating performance.

The ethylene-vinyl acetate copolymer used in the hot-melt adhesive composition preferably has a melt index of 2 to 5 g/10 minutes and a softening point of 150 to 190° C. as described above. When the melt index exceeds 5 g/10 minutes or the softening point is less than 150° C., the cohesive strength of the adhesive becomes insufficient and an adequate adhesive power at high temperature cannot be obtained. Moreover, the amount of adhesive penetrating the cloth increases and there is a possibility that the adhesive might penetrate into the pile side of the plush. On the other hand, when the melt index is less than 2 g/10 minutes or the softening point exceeds 190° C., a high load is applied to a resin extrusion motor of a coating device, the device tends to break down and it becomes difficult to extrude the hot-melt adhesive. With regard to the amount of an ethylene-vinyl acetate copolymer resin added, when it is less than 40 wt % adhesive strength at low temperature cannot be obtained, and when it exceeds 50 wt % the fluidity is degraded and the adhesive cannot be coated uniformly and steadily onto the light-shielding base fabric (the base fabric of the light-shielding cloth). With regard to the tackifier, when its melting point is less than 130° C., a heat resistant adhesive cannot be obtained, and the viscosity decreases thus causing non-uniformity in penetration of the resin. When the melting point exceeds 150° C., the adhesive has poor fluidity and cannot be coated on a light-shielding base fabric uniformly and steadily. In the adhesive composition, when the proportion of tackifier exceeds 35 wt %, since the tackiness of the adhesive becomes too high, there is a possibility that the adhesive might become attached to areas of a line that receive repetitive heating in a process for producing plush so causing a malfunction in the production line. There is also a possibility that resin residue might become attached to the final plush product. When the proportion of tackifier is less than 25 wt %, an intended adhesive power cannot be obtained. When the proportion of wax in the composition exceeds 20 wt %, the cohesive strength of the adhesive decreases, and an intended adhesive power cannot be obtained. Moreover, the viscosity decreases so causing a possibility that the adhesive might not penetrate uniformly. When the amount of wax is less than 10 wt %, since the open time of the adhesive increases, there is a possibility that blocking might be caused in the plush production process. With regard to the inorganic fine particles, when the content thereof exceeds 15 wt %, the fluidity of the adhesive is degraded, the adhesive cannot be coated uniformly and steadily on a light-shielding base fabric, and an intended adhesive strength cannot be obtained. When it is less than 5 wt %, an adequate cohesive strength of the adhesive cannot be obtained. In addition, the materials used in the hot-melt adhesive should not contain any component that causes fogging in a photographic material.

With regard to a method of coating the hot-melt adhesive used in the present invention, a coating device such as a hot-melt extrusion die coater made by either one of Nordson or Yuri Roll Machine Co., Ltd. can be used. The method of feeding the hot-melt adhesive in the coating device is not particularly limited, but since the adhesive used in the present invention is of a type having a high viscosity, it is preferable to melt the adhesive by means of a heated cylinder and feed it using a screw system. The adhesive is coated directly onto the reverse side (base surface) of the plush base fabric using a coating device such as an extrusion die coater. The direct coating can increase the effect of the adhesive in anchoring the filaments to the base surface of the plush base fabric, thus giving high adhesive strength. The temperature of the hot-melt adhesive when coated is preferably at a level that does not cause thermal degradation of the light-shielding plush in the case where the light-shielding plush is formed from a synthetic fiber. In the present invention, ‘base surface’ has the same meaning as that of ‘base fabric surface’. The synthetic fiber referred to here denotes one formed from a thermoplastic resin such as a polyester system, for example, polyethylene terephthalate or a polyamide system, for example, nylon. When the plush material is a synthetic fiber such as, for example, polyethylene terephthalate or nylon-66, the temperature of the adhesive when coated is preferably 200° C. or below, and more preferably 150 to 180° C.

The viscosity of the hot-melt adhesive when coated needs to be adjusted according to its physical properties and the coating temperature, and is preferably from 200,000 to 700,000 mPa·s, and more preferably 400,000 to 600,000 mPa·s. When it is less than 200,000 mPa·s, there is a possibility that the adhesive might penetrate through to the pile side. When it exceeds 700,000 mPa·s, the penetration and attachment of the resin to the base fabric are degraded, there is a possibility that a high degree of fraying might be caused during cutting the plush on the production line, and it becomes difficult to carry out smooth and uniform coating. Moreover, it is desirable to set the clearance between the coating head and the back-up roll of the coating device during coating in the range from 0.4 mm to 1.0 mm. When the clearance is less than 0.4 mm, since the pile is strongly compressed, there is a possibility that the pile might be crushed or the running performance of the base fabric might be degraded. When the clearance is more than 1.0 mm, since the force that presses the adhesive against the base fabric decreases, an adequate anchoring effect cannot be obtained and the adhesive strength might be degraded. The amount of adhesive coated is preferably 90 to 150 g/m². When the amount coated is less than 90 g/m², an intended adhesive strength cannot be obtained, and when the amount coated is more than 150 g/m², in an ultrasonic slitting step of the process for the production of a plush ribbon, there is a possibility that the amount of resin residue attached to the ribbon might increase, and there is also a possibility that the adhesive might be transferred to a cartridge shell when thermally pressing the ribbon onto the cartridge shell so degrading the appearance of the cartridge.

With regard to a light-shielding cloth suitable for coating with the hot-melt adhesive, it is preferable for the pile density on the pile side to be 45,000 to 85,000 filaments/cm² and for the pile compression characteristic to be such that the percentage change in thickness is 15 to 25% under a load of 0.49 N/cm² and 26 to 45% under a load of 1.96 N/cm² when the pile thickness is 1.6 mm or less. The percentage change in thickness referred to here denotes a percentage decrease in thickness due to the load relative to the initial thickness. This characteristic can be obtained by appropriately combining the thickness, the cross-sectional shape, the type and the processed form of the pile threads. By introducing the above-mentioned pile density and compression characteristics to the pile threads, the pile threads will not be crushed by a pressure that presses the adhesive into the base surface when coating the adhesive. A good quality light-shielding plush having small drawing resistance and good light-shielding properties when used in a film cartridge can thereby be obtained. For example, when an 84 decitex/72 filament polyester textured yarn having a single filament decitex of 1.16 decitex is used at a pile density of 50,000 to 60,000 filaments/cm², the above-mentioned good pile characteristic can be obtained. In the same type of textured yarn, when a 84 decitex/36 filaments polyester textured yarn having a single filament decitex of 2.31 decitex is used, the percentage change in thickness with a load of 1.96 N/cm² becomes less than 26%, and although the pile is not crushed during coating, since the drawing resistance of a film cartridge increases, it is preferable for the single filament decitex to be smaller. It is necessary for the thickness of the plush to be set according to the gap size of the slit-form opening of the cartridge main body to which the plush is bonded, and it is preferably set at a level that is larger than half the gap size by 0.05 to 0.3 mm. When it is larger by less than 0.05 mm the light-shielding properties might be greatly degraded, and when it is larger by more than 0.3 mm the drawing resistance might increase.

The base fabric preferably has a woven or warp knitted structure which gives a smooth base surface and good coating performance with an adhesive. Among the warp knitted structures, a chain/inlay fabric and a chain/satin fabric disclosed by the present applicant in Japanese Utility Model Registration Publication No. 7-50741 are preferred. The use of such a fabric reduces the roughness of the base surface so improving the coating performance, and an intended adhesive strength can be obtained with a smaller amount of adhesive coated. In the case of the chain/inlay fabric, a 56 to 110 decitex multi-filament thread is preferably used; it is also possible to use a combination of filament threads having different decitex values, but in order to introduce the anchoring effect between the adhesive and the fabric, the number of filaments is preferably 45 or below. When the thickness of the thread exceeds 110 decitex, the slitting performance in an ultrasonic slitting step of the process for producing a plush ribbon might be degraded. When the thickness of the thread becomes thinner than 56 decitex, the strength of the base fabric becomes poor, the rigidity of the final plush product is degraded, and there is a possibility that the plush might not be able to be bonded stably to a predetermined position of a cartridge main body. The materials for the pile thread and the base fabric thread used for a plush having the above-mentioned warp knitted or woven structure are preferably formed from a single synthetic fiber, but combinations of more than one type of synthetic fiber can be used.

The light-shielding cloth used in the present invention is preferably formed from a black thread and contains an antistatic material and a conductive material as described in Japanese Utility Model Registration Publication No. 4-23236 and Japanese Utility Model Registration Application Laid-open No. 4-33040 in order to ensure the presence of the light-shielding function and prevent the occurrence of static electricity when drawing photographic film. With regard to coloring methods, the whole cloth can be dyed (post dyeing) or a black dyed thread can be used. The black dyed thread is formed by kneading thread with carbon black; in general, carbon black has good light absorption over a wide range including ultraviolet, visible and infrared light, and it is therefore possible to use it in the case of photosensitive materials which absorb light at various wavelengths. Commercial black dyed threads normally have a single filament decitex of 2 or above. As described above, when an 84 decitex/36 filament processed polyester thread having a single filament decitex of 2.31 is used, the percentage change in thickness with a load of 1.96 N/cm² is less than 26% and, although the pile is not crushed during coating, there is a possibility that the drawing resistance of a film cartridge might increase. Taking into consideration the cost, it is desirable to employ a commercial thread, and in this case by using a mixture of a regular thread and a black dyed thread as a pile thread an intended compression characteristic can be obtained. When a combination of an 84 decitex/72 filaments processed polyester thread and a 84 decitex/36 filaments processed black dyed polyester thread is used as a pile thread, the mixing ratio of the black dyed thread in the pile thread is preferably 5 wt % to 60 wt %, and more preferably 10 wt % to 30 wt %.

The light-shielding cloth used in the present invention can be cut (slit) into a required width after making a wide-width product (500 mm or more) or can be made so as to have a required width in the first place. With regard to methods of slitting the wide-width product while preventing pile drop, there are a method of hot melt cutting by means of a hot blade disclosed in Japanese Utility Model Registration Publication No. 48-35790 and a method of cutting by means of, for example, an ultrasonic cutter, a laser cutter or a heat cutter, and an ultrasonic cutter is preferred.

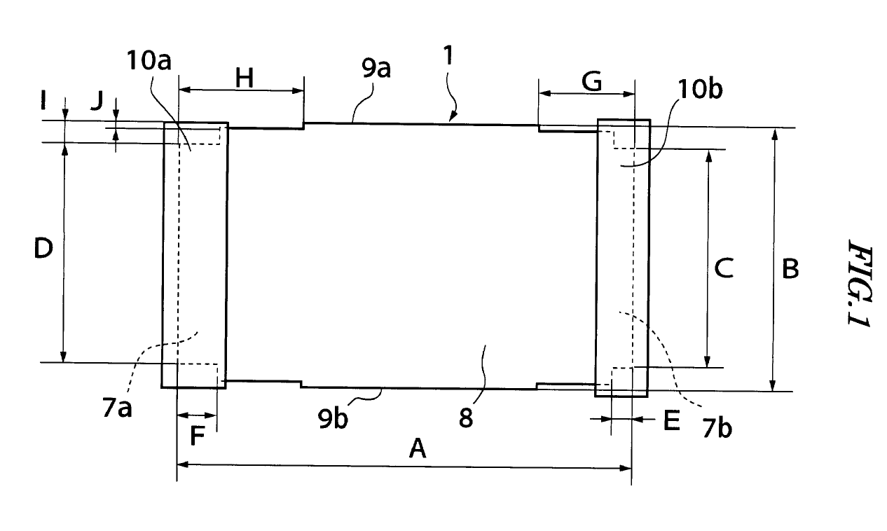

FIG. 1 is a front view of one example of a shell-forming metal sheet to which two pieces of light-shielding plush have been bonded to the right and left edges thereof. A shell-forming metal sheet 1 comprises port-forming sections 7a and 7b and a tube-forming section 8. Projections 9a and 9b, which are inserted into a lid member (not illustrated) and a base member (not illustrated) of a photographic film cartridge, are formed on the upper and lower parts of the tube-forming section 8. The shell-forming metal sheet 1 shown in FIG. 1 has a length A in the width direction of 79.75 to 79.85 mm and a length B in the longitudinal direction of 42.15 to 42.25 mm. The port-forming section 7a has a length D in the longitudinal direction of 35.8 to 36.0 mm and a length F in the width direction of 7.1 to 7.3 mm. The port-forming section 7b has a length C in the longitudinal direction of 35.8 to 36.0 mm and a length E in the width direction of 3.4 to 3.6 mm. A length H in the width direction from the edge of the port-forming section 7a to the edge of the projection 9a of the tube-forming section 8 is 21.15 to 21.40 mm. A length G in the width direction from the edge of the port-forming section 7b to the edge of the projection 9a of the tube-forming section 8 is 17.3 to 17.5 mm. A length I in the longitudinal direction from the edge of the projection 9a of the tube-forming section 8 to the edge of the port-forming section 7a is 3.1 to 3.2 mm. A length J in the longitudinal direction of the projection 9a of the tube-forming section 8 is 0.5 to 0.6 mm.

Two pieces of light-shielding plush 10a and 10b shown in FIG. 1 are both formed by cutting long light-shielding plush ribbons that are bonded to the shell-forming metal sheet 1 so that the two ends of each of the ribbons in the longitudinal direction project beyond the tube-forming section 8 by 1 to 2 mm. The light-shielding plush 10a has a width of 11.4 to 11.6 mm, and the edge in the width direction projects beyond the port-forming section 7a by 1.0 to 2.5 mm. The light-shielding plush 10b has a width of 9.4 to 9.6 mm, and the edge in the width direction projects beyond the port-forming section 7b by 1.0 to 2.5 mm.

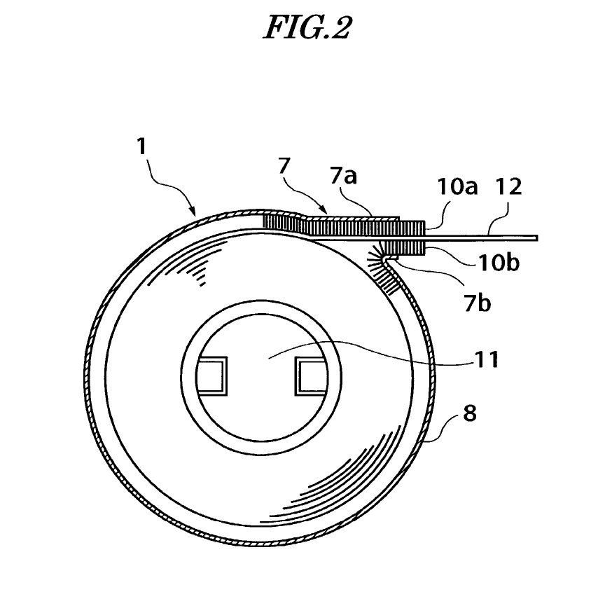

FIG. 2 is a cross section of one example of a photographic film cartridge formed from the shell-forming metal sheet with light-shielding plush shown in FIG. 1. A film case of the photographic film cartridge is formed by bending the tube-forming section 8 of the shell-forming metal sheet 1 shown in FIG. 1 into a tube form so that the two pieces of light-shielding plush 10a and 10b bonded to the port forming sections 7a and 7b come into contact with each other. A photographic film 12 wound around a spool 11 is drawn while the surfaces thereof are in contact with the two pieces of light-shielding plush 10a and 10b of a port section 7, and the photographic film inside the cartridge is thus shielded from light.

There is no restriction on the width of the light-shielding plush pieces 10a and 10b as long as they are in contact with the photographic film to an extent that can prevent the photographic film stored inside the cartridge from being exposed to light. For example, it is possible to make two pieces of light-shielding plush 10a and 10b with a width of 9.4 to 9.6 mm (the width corresponding to the depth from the port orifice of the photographic film cartridge). In particular, taking into consideration the productivity and control of the production of light-shielding plush, it is preferable for the two pieces of light-shielding plush 10a and 10b to have a narrow and identical width. In addition, when the two pieces of light-shielding plush 10a and 10b have a width of 9.4 to 9.6 mm, the length F in the width direction of the port forming section 7a of the shell-forming metal sheet 1 shown in FIG. 1 is preferably 3.5 to 4.0 mm so as to enhance the light-shielding properties of the photographic film cartridge.

When producing plush, after subjecting the wide-width light-shielding cloth to ultrasonic slitting, the narrow-width light-shielding cloth so formed is wound around a plastic reel while traversing from the top to the bottom of the reel. If the wind tension at this point is too low, the wound form collapses during transport, and it becomes impossible to draw out the narrow light-shielding cloth on-site. When the wind tension is too high, the pile is crushed so causing degradation of the light-shielding properties.

The above-mentioned cartridge is formed by, for example, firstly cutting a metal sheet into a predetermined shape, forming the sheet into a shape having an approximately boat-shaped cross section, bonding the above-mentioned two pieces of plush to the right and left edges of the metal sheet and then bending the metal sheet into an approximately tube shaped form so that the two pieces of plush face each other.

With regard to methods of bonding the plush to the metal sheet, there are a method in which the plush is cut to a predetermined length beforehand, the metal sheet is fed intermittently and the precut plush is bonded to the metal sheet piece by piece when the sheet is stopped, and methods disclosed in Japanese Patent Application Laid-open Nos. 59-143841, 63-74869 and 7-301888 and Japanese Patent Publication No. 5-53256 for enhancing the productivity by increasing the speed of the bonding step. In the methods with enhanced productivity, which are practical, a plurality of metal sheets are continuously fed in a state in which they are arranged so that the forward end of one sheet is almost in contact with the back end of the foregoing sheet, two long plush ribbons precoated with an adhesive are continuously bonded to the right and left edges respectively of the metal sheets so arranged, and the plush ribbons are then cut by passing a cutter blade between adjoining metal sheets.

The light-shielding cloth of the present invention can be used as, for example, a light-shielding cloth provided at a passage port of a cartridge for various types of photosensitive material such as, for example, photographic film, printing paper and photosensitive resin film and a lining for the purpose of light-shielding in a machine such as a photographic developing machine handling a photosensitive material. In particular, the light-shielding container of the present invention can be desirably applied to a container having a structure in which one of various types of photographic film is stored so as to prevent exposure to light and the film is drawn out through a passage port, and particularly desirably a cartridge storing various types of sheet-form or roll-form photographic material (JIS 135 size photographic film, color printing paper, computer phototypesetting film and paper, thermal paper, photosensitive resin film, microfilm, X-ray film, etc.).

### EXAMPLES

The present invention is now explained in detail below by reference to examples.

### Example 1

The base fabric for the light-shielding plush used in this example was a knitted fabric having a chain/inlay structure disclosed in Japanese Utility Model Registration Publication No. 7-50741 and the plush was formed using 84 decitex/36 filaments polyester threads as the chain and inlay threads of the base fabric and an 84 decitex/72 filaments polyester textured yarn as the pile thread. Two sheets of the base fabric were knitted together by the pile thread using a double Raschel machine so that the knitting gauge was 22 and the course density was 50. The two sheets of base fabric so obtained were cut centrally to give two pieces of light-shielding knitted pile. The pile thread so cut had a pile thickness of 2.2 mm. The polyester textured yarn used as the pile thread was obtained by heating twice using a 3-shaft outer-contact type false twist friction texturing machine. The base fabric obtained by cutting centrally in this way was then subjected to a pre-shearing step in which the length of the pile was adjusted as appropriate and the pile was brushed while heating at 120° C. The pile was further subjected to a preset step in which the pile was crimped by heating at 190° C., a dyeing step for the purpose of introducing light-shielding properties, and then a drying step. As a result of final shearing, the pile thickness was adjusted to 1.4 mm. A light-shielding cloth having a compression characteristic that showed a percentage change in thickness of 20% mm with a load of 0.49 N/cm² and a percentage change in thickness of 32% with a load of 1.96 N/cm² when the pile thickness was 1.4 mm was obtained. The course density was 50, the wale density was 26 and the pile density was 58,000 filaments/cm².

The base surface of the plush so adjusted was coated with a 100% solids hot-melt adhesive so as to form an adhesive layer via which the light-shielding plush was to be bonded to a cartridge main body. The hot-melt adhesive used here was an ethylene-vinyl acetate type adhesive containing 45 wt % of an ethylene-vinyl acetate copolymer resin having a vinyl acetate content of 26%, a melt index of 2 g/10 minutes and a softening point of at least 160° C., 30 wt % of an aromatic petroleum resin tackifier having a melting point of 140° C., 10 wt % of talc and 15 wt % of a polyethylene wax having a melting point of 100° C. In order to introduce light-shielding properties, 3 wt % of carbon black was further added to the hot-melt adhesive, and the mixture was kneaded well to disperse the carbon black. The hot-melt adhesive so prepared was coated at 100 g/m² on the base surface of the light-shielding plush at a resin temperature of 170° C. using a GPD hot-melt die coater (manufactured by Yuri Roll Machine Co., Ltd.). The light-shielding plush with a single layer of the hot-melt adhesive so coated was slit into 11.5 mm and 9.5 mm widths to give light-shielding plush ribbons.

Subsequently, the plush ribbons so formed were continuously bonded to right and left edges of each of a plurality of cartridge shell-forming sheets while employing conveying means for continuously conveying the plurality of sheets arranged so that the forward end and the back end of adjoining sheets were in close contact with each other, that is to say, the right edges and the left edges of the sheets were each arranged in a line, and pressing means for pressing the two long plush ribbons precoated with adhesive against the right and left edges of the sheets that were being conveyed. The long plush ribbons so bonded were cut from their reverse sides between each of the sheets to give cartridge shell sheets with plush attached. An ISO 400 sensitivity color negative film (Fujicolor SUPERIA 400 (product name), manufactured by Fuji Photo Film Co., Ltd.) was wound around spools and stored in cartridges formed from each of the shell sheets, and quality characteristics such as the light-shielding properties and the drawing resistance were evaluated in this state.

### Example 2

The base fabric for the light-shielding plush used in this example was a knitted fabric having a chain/inlay structure disclosed in Japanese Utility Model Registration Publication No. 7-50741 and the plush was formed using an 84 decitex/36 filaments polyester thread as the chain thread of the base fabric, a 56 decitex/24 filaments polyester thread as the inlay thread thereof and an 84 decitex/72 filaments polyester textured yarn as the pile thread. Two sheets of the base fabric were knitted together by the pile thread using a double Raschel machine so that the knitting gauge was 22 and the course density was 52. The two sheets of base fabric so obtained were cut centrally to give two pieces of light-shielding knitted pile. The pile thread so cut had a pile thickness of 2.2 mm. The polyester textured yarn used as the pile thread was obtained by heating twice using a 3-shaft outer-contact type false twist friction texturing machine. The base fabric obtained by cutting centrally in this way was then subjected to a pre-shearing step in which the length of the pile was adjusted as appropriate and the pile was brushed while heating at 120° C. The pile was further subjected to a preset step in which the pile was crimped by heating at 190° C., a dyeing step for the purpose of introducing light-shielding properties, and then a drying step. It was finally subjected to a shearing step to adjust the length of the pile to 1.50 mm. As a result, a light-shielding plush having a compression characteristic that showed a percentage change in thickness of 18% mm with a load of 0.49 N/cm² and a percentage change in thickness of 30% with a load of 1.96 N/cm² when the pile thickness was 1.5 mm was obtained. The course density was 54, the wale density was 26 and the pile density was 62,700 filaments/cm².

The base surface of the plush so adjusted was coated with a 100% solids hot-melt adhesive so as to form an adhesive layer via which the light-shielding plush was to be bonded to a cartridge main body. The hot-melt adhesive used here was an ethylene-vinyl acetate type adhesive containing 20 wt % of an ethylene-vinyl acetate copolymer resin having a vinyl acetate content of 19%, a melt index of 2 g/10 minutes and a softening point of 185° C., 25 wt % of an ethylene-vinyl acetate copolymer resin having a vinyl acetate content of 28%, a melt index of 6 g/10 minutes and a softening point of 160° C., 30 wt % of an aromatic petroleum resin tackifier having a melting point of 140° C., 10 wt % of talc and 15 wt % of a polyethylene wax having a melting point of 100° C. The hot-melt adhesive so prepared was coated at 110 g/m² on the base surface of the light-shielding plush at a resin temperature of 170° C. using a GPD hot-melt die coater (manufactured by Yuri Roll Machine Co., Ltd.). Thereafter, the procedure of Example 1 was repeated to give a sample.

### Comparative Example 1

The base fabric for the light-shielding plush used in this example was a knitted fabric having a chain/inlay structure disclosed in Japanese Utility Model Registration Publication No. 7-50741 and the plush was formed using 84 decitex/36 filaments polyester threads as the chain and inlay threads of the base fabric and an 84 decitex/36 filaments polyester textured yarn as the pile thread. Two sheets of the base fabric were knitted together by the pile thread using a double Raschel machine to give an erect pile cloth having 29,000 filaments/cm². Thereafter, the procedure of Example 1 was repeated to give a sample.

### Example 3

A base fabric was prepared in the same manner as in Example 1. A 100% solids hot-melt adhesive was coated on the base fabric. The hot-melt adhesive used here was an ethylene-vinyl acetate type adhesive containing 45 wt % of an ethylene-vinyl acetate copolymer resin having a vinyl acetate content of 28%, a melt index of 6 g/10 minutes and a softening point of 160° C., 40 wt % of an aromatic petroleum resin tackifier having a melting point of 140° C., 10 wt % of talc and 5 wt % of a polyethylene wax having a melting point of 100° C. In order to introduce light-shielding properties, 3 wt % of carbon black was further added to the hot-melt adhesive, and the mixture was kneaded well to disperse the carbon black. The hot-melt adhesive so prepared was coated at 100 g/m² on the base surface of the light-shielding plush at a resin temperature of 170° C. using a GPD hot-melt die coater (manufactured by Yuri Roll Machine Co., Ltd.). Thereafter, the procedure of Example 1 was repeated to give a sample.

### Example 4

A base fabric was prepared in the same manner as in Example 1. A 100% solids hot-melt adhesive was coated on the base fabric. The hot-melt adhesive used here was an ethylene-vinyl acetate type adhesive containing 35 wt % of an ethylene-vinyl acetate copolymer resin having a vinyl acetate content of 19%, a melt index of 2 g/10 minutes and a softening point of 185° C., 30 wt % of an aromatic petroleum resin tackifier having a melting point of 140° C., 10 wt % of talc and 25 wt % of a paraffin wax having a melting point of 70° C. In order to introduce light-shielding properties, 3 wt % of carbon black was further added to the hot-melt adhesive, and the mixture was kneaded well to disperse the carbon black. The hot-melt adhesive so prepared was coated at 100 g/m² on the base surface of the light-shielding plush at a resin temperature of 170° C. using a GPD hot-melt die coater (manufactured by Yuri Roll Machine Co., Ltd.). Thereafter, the procedure of Example 1 was repeated to give a sample.

### Comparative Example 2

The base fabric for the light-shielding plush used in this example was a knitted fabric having a chain/inlay structure disclosed in Japanese Utility Model Registration Publication No. 7-50741 and the plush was formed using 33 decitex/18 filaments polyester threads as the chain and inlay threads of the base fabric and a 56 decitex/36 filaments polyester regular thread as the pile thread. Two sheets of the base fabric were knitted together by the pile thread using a double Raschel machine so that the knitting gauge was 22 and the course density was 70. The two sheets of base fabric so obtained were cut centrally to give two pieces of light-shielding knitted pile. The pile thread so cut had a pile thickness of 2.2 mm. The base fabric obtained by cutting centrally in this way was then subjected to a pre-shearing step in which the length of the pile was adjusted as appropriate and the pile was brushed while heating at 120° C. The pile was further subjected to a preset step at 190° C., a dyeing step for the purpose of introducing light-shielding properties, then a drying step and finally a shearing step to adjust the length of the pile to 1.60 mm. As a result, a light-shielding plush having a compression characteristic that showed a percentage change in thickness of 22% with a load of 0.49 N/cm² and a percentage change in thickness of 40% with a load of 1.96 N/cm² when the pile thickness was 1.6 mm was obtained. The course density was 70, the wale density was 28 and the pile density was 41,300 filaments/cm².

In order to prevent adhesive from penetrating through to the front surface of the plush while applying the adhesive to the base fabric and in order to form an adhesive layer via which the plush could be bonded to a cartridge main body, a vinyl acetate series emulsion as a filling agent were coated on the base surface of the plush, and a toluene based adhesive containing an ethylene-vinyl acetate copolymer as a principal component were coated thereon. The vinyl acetate system emulsion used here was 50% solids and its viscosity was 100,000 mPa·s. In order to give light-shielding properties, 2 wt % of a black dye was added to the vinyl acetate series emulsion and 2 wt % of black pigments was added to the ethylene-vinyl acetate copolymer system adhesive. The adhesive containing the ethylene-vinyl acetate copolymer as a principal component was 28% solids. Since the adhesive was solid at room temperature, it was heated to 65° C. to lower its viscosity to 700 mPa·s when coated. A reverse roll coater was used and coating was carried out so that the amount of filling agent coated was 40 g/m² and the amount of adhesive coated was 70 g/m². Thereafter, the procedure of Example 1 was repeated to give a sample.

### Comparative Example 3

A base fabric was prepared in the same manner as in Comparative Example 2. A 100% solids hot-melt adhesive was coated on the base fabric. The hot-melt adhesive used here was an ethylene-vinyl acetate type adhesive containing 45 wt % of an ethylene-vinyl acetate copolymer resin having a vinyl acetate content of 26%, a melt index of 2 g/10 minutes and a softening point of at least 160° C., 30 wt % of an aromatic petroleum resin tackifier having a melting point of 140° C., 10 wt % of talc and-15 wt % of a polyethylene wax having a melting point of 100° C. In order to introduce light-shielding properties, 3 wt % of carbon black was further added to the hot-melt adhesive, and the mixture was kneaded well to disperse the carbon black. The hot-melt adhesive so prepared was coated at 100 g/m² on the base surface of the light-shielding plush at a resin temperature of 170° C. using a GPD hot-melt die coater (manufactured by Yuri Roll Machine Co., Ltd.). Thereafter, the procedure of Example 1 was repeated to give a sample.

TABLE 1

| | Examples | | | | Comparative Examples | | |
|---|---|---|---|---|---|---|---|
| | 1 | 2 | 3 | 4 | 1 | 2 | 3 |
| Pile density (filaments/cm²) | 58,000 | 62,700 | 58,000 | 58,000 | 29,000 | 41,300 | 41,300 |
| Pile thread processed | Yes | Yes | Yes | Yes | Yes | No | No |
| Treatment with filling agent | No | No | No | No | No | Yes | No |
| Thickness after coating adhesive | 1.4 | 1.5 | 1.4 | 1.4 | 1.4 | 1.6 | 1.6 |
| (mm) | | | | | | | |
| Suitability for ultrasonic slitting | AA | AA | CC | AA | AA | AA | AA |
| Adhesive strength (N/11.5 mm) | 14.7 | 14.7 | 19.6 | 9.80 | 14.7 | 11.8 | 14.7 |
| Thread drop | AA | AA | BB | AA | AA | AA | AA |
| Light-shielding properties | AA | AA | AA | AA | AA | BB | CC |
| Drawing resistance | AA | AA | AA | AA | CC | AA | AA |
| Cost | AA | AA | AA | AA | AA | CC | BB |

From the results of Table 1, it could be confirmed that the products of the present invention were superior to the conventional products in terms of both equipment compatibility and quality. AA denotes very good, BB denotes applicable without problem, and CC denotes applicable with the possibility of a problem occurring, which is preferably to be improved.

Method of Evaluation

Thickness: Measured using a Peacock dial gauge model G.

Suitability for ultrasonic slitting: Slitting was carried out using an ultrasonic slitter with a frequency of 15 KHz and an amplitude of 40 μm at a speed of 5 m/minute. The state and the amount of resin residue attached to the ribbon after slitting were evaluated visually.

AA: The number of pieces of resin residue attached per 10 m of the narrow light-shielding cloth was less than 10.

BB: The number was 10 or more but less than 30.

CC: The number was 30 or more.

Adhesive strength: A ribbon sample slit (cut) into a 11.5 mm width was pressure bonded to the inner surface of a metal sheet that was used as a cartridge shell sheet at 140° C. with a load of 1.08 N/cm² for 3 seconds, allowed to stand at 20° C. for 24 hours and subjected to a peel test at 1800 using an Autograph (manufactured by SHIMADZU CORPORATION) at a pulling speed of 300 mm/minute.

Thread drop: A pressure-sensitive adhesive tape (generally called cellophane tape such as, for example, cellotape manufactured by NICHIBAN COMPANY, LIMITED) was bonded to the surface of the plush. The pressure-sensitive adhesive tape and the plush were pressed together by means of a pressure roll having a weight of 2 kg, a width of 45 mm and a diameter of 95 mm. The pressure-sensitive adhesive tape was then peeled off the plush, the number of pieces of thread attached to the pressure-sensitive adhesive tape was counted and the number of pieces of thread per unit area of the plush was thus calculated.

Light-shielding properties: A sample was conditioned by standing at room temperature for 24 hours and then exposed to light by applying light at 90,000 lux to the port opening, the photographic film was developed and the photographic image was evaluated visually in terms of light exposure due to light invasion.

Drawing resistance: A sample was conditioned by standing at room temperature for 24 hours and then subjected to a measurement of drawing force using an Instron Tensile Tester.

Although the present invention has been fully described by way of preferred embodiments thereof with reference to the accompanying drawings, various changes and modifications will be apparent to those having skill in the field. Therefore, unless these changes and modifications otherwise depart from the scope of the present invention, they should be construed as being included therein.

What is claimed is:

1. A light-shielding cloth comprising:
a base fabric having first and second opposing surfaces;
crimped pile threads incorporated into the base fabric and protruding from said first surface of the base fabric, said threads having a pile density in the range of 45,000 filaments/cm² to 85,000 filaments/cm²; and
a hot-melt adhesive provided on said second surface of the base fabric, without a filling agent between the base fabric and the adhesive.

2. A light-shielding container for a photosensitive material formed by providing a light-shielding member on a slit-form opening through which the photosensitive material passes, the two sides of the slit-form opening comprising in cross section:
a light-shielding container main body;
a hot-melt adhesive region; and
a light-shielding cloth comprising a base fabric having first and second opposing surfaces, crimped pile threads incorporated into the base fabric and protruding from said first surface of the base fabric, said threads having a pile density in the range of 45,000 filaments/cm² to 85,000 filaments/cm², without a filling agent being applied to the second surface of the base fabric.

3. A narrow-width light-shielding cloth obtained by cutting the wide-width light-shielding cloth according to claim 1 by means of an ultrasonic slitter.

4. The light-shielding cloth according to claim 1 wherein the composition of the hot-melt adhesive is 40 to 50 parts by weight of an ethylene-vinyl acetate copolymer resin, 25 to 35 parts by weight of a tackifier, 5 to 15 parts by weight of inorganic fine particles and 10 to 20 parts by weight of a wax.

5. The light-shielding container for a photosensitive material according to claim 2 wherein the composition of the hot-melt adhesive is 40 to 50 parts by weight of an ethylene-vinyl acetate copolymer resin, 25 to 35 parts by weight of a tackifier, 5 to 15 parts by weight of inorganic fine particles and 10 to 20 parts by weight of a wax.

6. The light-shielding cloth according to claim 3 wherein the composition of the hot-melt adhesive is 40 to 50 parts by weight of an ethylene-vinyl acetate copolymer resin, 25 to 35 parts by weight of a tackifier, 5 to 15 parts by weight of inorganic fine particles and 10 to 20 parts by weight of a wax.

7. The light-shielding cloth according to claim 3 wherein the width is 2 to 30 mm.

8. The light-shielding cloth according to claim 1 wherein the pile thread has a thickness of 56 to 110 decitex and is formed from 25 to 100 filaments.

9. The light-shielding container for a photosensitive material according to claim 2 wherein the pile thread has a thickness of 56 to 110 decitex and is formed from 25 to 100 filaments.

10. The light-shielding cloth according to claim 1 wherein the pile density is 50,000 to 75,000 filaments/cm².

11. The light-shielding container for a photosensitive material according to claim 2 wherein the pile density is 50,000 to 75,000 filaments/cm².
